(19) United States
(12) Patent Application Publication
(10) Pub. No.: US 2013/0208090 A1
(43) Pub. Date: Aug. 15, 2013

(54) HIERARCHICAL BROADCASTING SYSTEM AND METHOD FOR 3D BROADCASTING

(71) Applicants: Keun-Sik Lee, Seoul (KR); Byung-Sun Kim, Seoul (KR); Chang-Seob Park, Seoul (KR); Sang-Jin Hahm, Seoul (KR); In-Joon Cho, Seoul (KR); Jun-Yong Lee, Seoul (KR)

(72) Inventors: Keun-Sik Lee, Seoul (KR); Byung-Sun Kim, Seoul (KR); Chang-Seob Park, Seoul (KR); Sang-Jin Hahm, Seoul (KR); In-Joon Cho, Seoul (KR); Jun-Yong Lee, Seoul (KR)

(73) Assignee: KOREAN BROADCASTING SYSTEM, Seoul, KR (KR)

(21) Appl. No.: 13/881,141

(22) PCT Filed: Oct. 26, 2010
(86) PCT No.: PCT/KR10/07393

§ 371 Date: Apr. 23, 2013

(51) Int. Cl. H04N 13/00

(52) U.S. Cl. CPC H04N 13/0059
USPC 348/43

(57) ABSTRACT

Disclosed are a hierarchical broadcasting system and method for 3D broadcasting. A hierarchical 3D image broadcasting method comprises: allowing a broadcast transmission system to transmit first broadcast data for an existing broadcast to a broadcast reception system via a first communication network; and allowing the broadcast transmission system to transmit second broadcast data for 3D image broadcasting to the broadcast reception system via a second communication network. At this point, the broadcast reception system enables the first and second broadcast data to be combined in order to display a 3D image broadcast.

### TECHNICAL FIELD

The present invention relates to a hierarchical broadcasting system and method for a three-dimensional (3D) broadcasting service, and more particularly, to a system and method that provides a 3D image broadcasting service, using a heterogeneous network or a homogeneous network.

### BACKGROUND ART

Although a terrestrial digital broadcasting system may provide a higher quality broadcast than an analog broadcasting system by providing high definition content, a demand for a three-dimensional (3D) image that allows a realistic view irrespective of a moving direction and speed of an object is increasing.

Image data of at least two viewpoints may be transmitted to provide the 3D image. However, a current broadcasting system faces a difficulty in providing the 3D image due to a lack of a frequency and a compatibility issue with an existing broadcasting apparatus.

Accordingly, there is a need for a broadcasting system and method that provides a 3D image as well as achieves a compatibility with a current broadcasting apparatus.

### DISCLOSURE OF INVENTION

### Technical Goals

Example embodiments provide a broadcasting system and method that supports a three-dimensional (3D) image broadcasting service as well as achieves a compatibility with a current broadcasting apparatus as a 3D image broadcasting service is provided using a heterogeneous network or a homogeneous network.

Example embodiments also provide a broadcasting system and method that provides a 3D image broadcasting service as well as achieves a compatibility with a current broadcasting apparatus associated with a mobile broadcasting service, a satellite broadcasting service, and the like, as well as an existing terrestrial broadcasting service.

### Technical Solutions

According to an aspect of the present invention, there is provided a hierarchical broadcasting system for a three-dimensional (3D) image broadcasting service, the system including a first encoder unit to generate a first encoding signal by encoding a first broadcast data based on a first encoding scheme, a first transmission unit to transmit the first encoding signal via a first communication network, a residual signal generating unit to generate a residual signal from the first broadcast data and a second broadcast data, a second encoder unit to generate a second encoding signal by encoding the residual signal based on a second encoding scheme.

According to an aspect of the present invention, there is provided a hierarchical broadcasting method for a 3D broadcasting service, the system including transmitting a first broadcast data for an existing broadcasting service, by a broadcasting transmission system, to a broadcast reception system via a first communication network, and transmitting, by the broadcast transmission system, a second broadcast data for a 3D image broadcast to the broadcast reception system via a second communication network.

### Effects of Invention

According to example embodiments of the present invention, there is provided a hierarchical broadcasting system and method for a three-dimensional (3D) broadcasting service that provides a 3D image broadcast as well as achieves a compatibility with a current broadcasting apparatus through providing the 3D image broadcasting service using a heterogeneous network or a homogeneous network.

### BRIEF DESCRIPTION OF DRAWINGS

FIGS. 1 and 2 are diagrams illustrating a configuration of a hierarchical broadcasting system for a three-dimensional (3D) broadcasting service according to an example embodiment of the present invention.

FIG. 3 is a flowchart illustrating a hierarchical broadcast transmission method for a 3D broadcasting service according to an example embodiment of the present invention.

FIG. 4 is a flowchart illustrating a hierarchical broadcast reception method for a 3D broadcasting service according to an example embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

According to a fundamental principle of supporting a three-dimensional (3D) broadcasting service of the present invention, a broadcast transmission system may transmit a first broadcast data for an existing broadcast to a broadcast reception system via a first communication network, and transmit a second broadcast data for the 3D image broadcast to the broadcast reception system via a second communication network differing from the first communication network or a communication network identical to the first communication network. Here, the broadcast reception system may combine the first broadcast data and the second broadcast data to display the 3D image broadcast service. In this instance, the first broadcast data and the second broadcast data may refer to image data in a multi view or stereoscopic view scheme. In particular, the first broadcast data may correspond to left image data, and the second broadcast data may correspond to right image data. Here, the left image data and the right image data may refer to image data obtained by a left eye camera and a right eye camera to input an identical object into a left eye and a right eye, respectively.

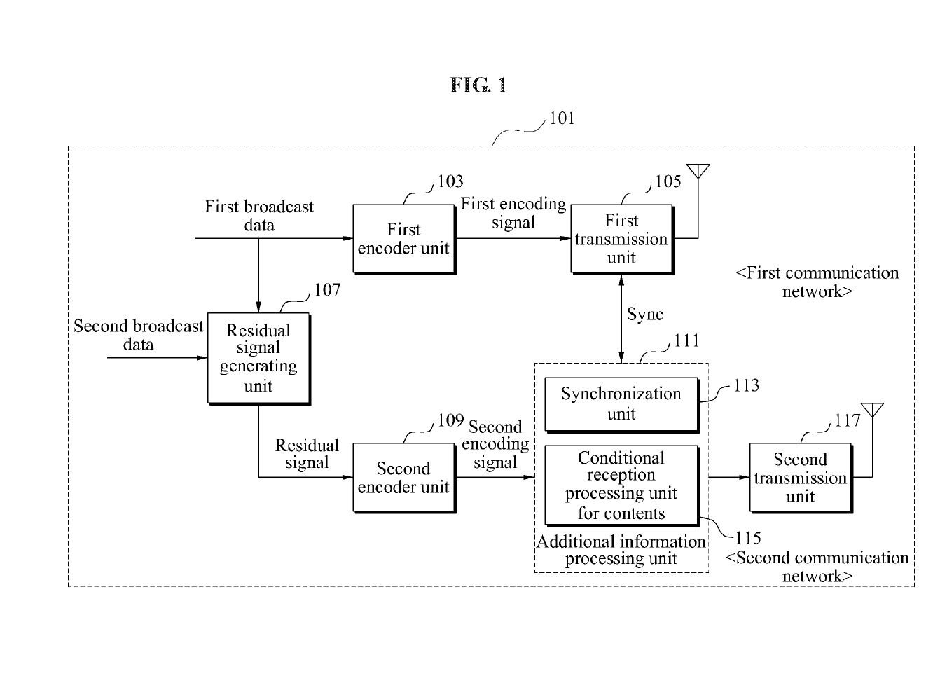

FIG. 1 is a diagram illustrating a configuration of a hierarchical broadcasting system 101 for a 3D broadcasting service according to an example embodiment of the present invention.

The hierarchical broadcasting system 101 for the 3D broadcast of FIG. 1 may be applied to a hierarchical broadcast transmission system for a 3D broadcasting service.

Referring to FIG. 1, the hierarchical broadcasting system 101 for the 3D broadcast may include a first encoder unit 103, a first transmission unit 105, a residual signal generating unit 107, a second encoder unit 109, an additional information processing unit 111, and a second transmission unit 117.

The first encoder unit 103 may generate a first encoding signal by encoding a first broadcast data based on a first encoding scheme. The first broadcast data, as used herein, may correspond to left image data. The first encoding scheme, as used herein, may refer to, but is not limited to, an encoding scheme pursuant to a Moving Picture Experts Group (MPEG)-2 standard. For example, when a digital multimedia broadcasting (DMB) is supported, the first encoding scheme may refer to an encoding scheme pursuant to an MPEG-4 Advanced Video Coding (AVC) standard.

The first transmission unit 105 may transmit the first encoding signal outputted from the first encoder unit 103 via the first communication network. In this instance, the first encoding signal may refer to a signal to which synchronization information between the first encoding signal and the second encoding signal is inserted. Here, the first communication network may refer to a broadcasting network for broadcasting a broadcast signal, and refer to, for example, a broadcasting network for an Advanced Television Systems Committee (ATSC) standard supporting a digital broadcast. Also, the first communication network may refer to, but is not limited to, a communication network that supports a mobile broadcasting service or a satellite broadcasting service.

The first transmission unit 105 may deliver synchronization information about the first encoding signal to the additional information processing unit 111.

The residual signal generating unit 107 may generate a residual signal from the first broadcast data and the second broadcast data. The second broadcast data, as used herein, may correspond to right image data. Here, the first broadcast data, being the left image data, and the second broadcast data, being the right image data, may refer to image data obtained by a camera for left eye and right eye to input an identical object to a left eye and a right eye. In particular, the residual signal generating unit 107 may generate a residual signal, using a difference between the left image data and the right image data.

The second encoder unit 109 may encode the residual signal between the first broadcast data and the second broadcast data, outputted from the residual signal generating unit 107, based on a second encoding scheme, to generate a second encoding signal. In this instance, a coding efficiency of the second encoding scheme may be higher than a coding efficiency of the first encoding scheme. The second encoding scheme may refer to, but is not limited to, an encoding scheme pursuant to the H.264 AVC standard.

The additional information processing unit 111 may include a synchronization unit 113, and a conditional reception processing unit 115 for contents.

The synchronization unit 113 may receive synchronization information about the first encoding signal from the first transmission unit 105, and based on a scheme for inserting the synchronization information between the first encoding signal and the second encoding signal, and the like, process the synchronization information, on the first encoding signal and the second encoding signal.

The conditional reception processing unit 115 for contents may perform encryption using a secret key, or scramble the second encoding signal, using a scramble code to allow only a service subscriber to receive contents.

The second transmission unit 117 may transmit the second encoding signal outputted from the additional information processing unit 111 via the second communication network. The second communication network, as used herein, may refer to a network differing from the first communication network, for example, an Internet network based on a network, or a communication network identical to the first communication network.

Information of a hierarchical 3D image broadcasting service may be inserted into at least one of the first encoding signal and the second encoding signal outputted from the first transmission unit 105 and the second transmission unit 117 to be transmitted. Here, the first encoding signal and the second encoding signal may be transmitted simultaneously, however, are not limited to such a transmission scheme, and may be transmitted sequentially or at predetermined intervals.

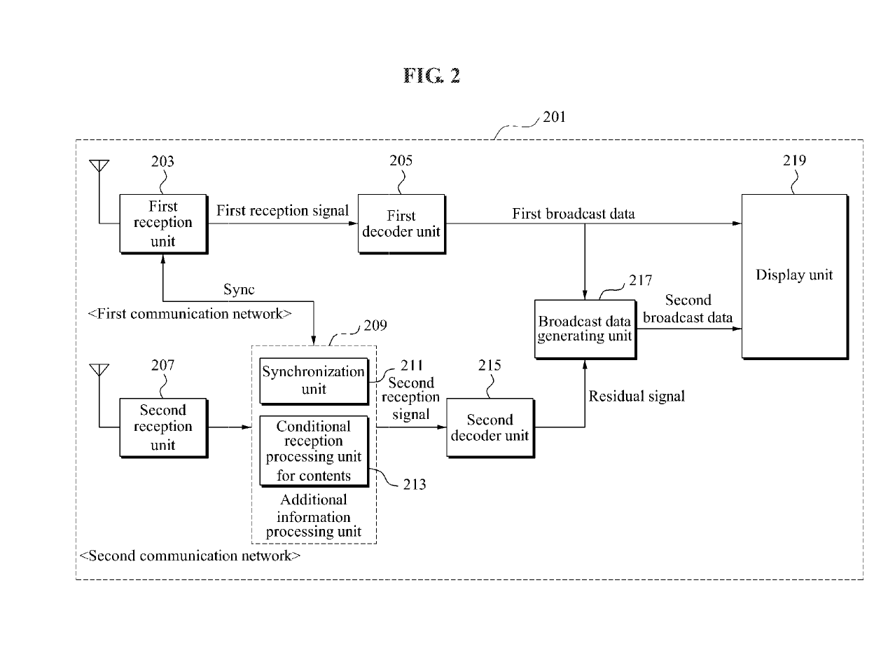

FIG. 2 is a diagram illustrating a configuration of a hierarchical broadcasting system 201 for a 3D broadcasting service according to an example embodiment of the present invention.

The hierarchical broadcasting system 201 for the 3D broadcasting service may be applied to a hierarchical broadcast reception system for a 3D broadcast.

Referring to FIG. 2, the hierarchical broadcasting system 201 for the 3D broadcasting service may include a first reception unit 203, a first decoder unit 205, a second reception unit 207, an additional information processing unit 209, a second decoder unit 215, a broadcast data generating unit 217, and a display unit 209.

The first reception unit 203 may receive first reception signal transmitted via a first communication network. The first communication network, as used herein, may refer to a broadcasting network for receiving a broadcast signal being broadcast, and may refer to, for example, a broadcasting network provided in the ATSC standard supporting a digital broadcast. Also, the first communication network may refer to, but is not limited to, a communication network supporting a mobile broadcasting service or a satellite broadcasting service.

The first decoder unit 205 may generate a first broadcast data by decoding the first reception signal based on a first decoding scheme. In this instance, the first broadcast data may correspond to left image data. The first decoding scheme may refer to, but is not limited to, a decoding scheme pursuant to the MPEG-2 standard. For example, when DMB is supported, the first decoding scheme may refer to a decoding scheme pursuant to the MPEG-4 AVC standard.

The second reception unit 207 may receive a second reception signal transmitted through a second communication network. Here, the second communication network may refer to a communication network differing from the first communication network, for example, an Internet network based on a network, or a communication network identical to the first communication network. Also, information of a hierarchical 3D image broadcasting service may be inserted into at least one of the first reception signal and the second reception signal.

The additional information processing unit 209 may include a synchronization unit 211 and a conditional reception processing unit 213 for contents.

The synchronization unit 211 may extract, from the second reception signal, synchronization information between the second reception signal and the first reception signal received via the first reception unit 203. The conditional reception processing unit 213 for contents may decrypt the second reception signal using a secret key identical to that use to perform the encryption, or descramble the second reception signal using a scramble code identical to that used for the scrambling. Here, the secret key or the scramble code may be provided through subscribing to a service.

The second reception signal outputted from the additional information processing unit 209 may be stored in a buffer (not shown) along with the first reception signal, and may be outputted based on the synchronization information.

The second decoder unit 215 may generate a residual signal between the first broadcast data and the second broadcast data by decoding the second reception signal based on the second decoding scheme. Here, the residual signal between the first broadcast data and the second broadcast data may refer to a residual signal between, for example, left image data and right image data. A decoding efficiency of the second decoding scheme may be higher than a decoding efficiency of the first decoding scheme. The second decoding scheme may comply with, for example, the H.264 AVC standard, but is not limited thereto.

The broadcast data generating unit 217 may generate the second broadcast data by combining an output signal of the first decoder unit 205 and an output signal of the second decoder unit 215. In particular, the broadcast data generating unit 217 may generate the left image data of the first broadcast data and the right image data corresponding to the second broadcast data from the residual signal between the first broadcast data and the second broadcast data, being the residual signal between the left image data and the right image data.

The display unit 219 may display a 3D image using the first broadcast data, being the output signal of the first decoder unit 205, and the second broadcast data, being the output signal of the broadcast data generating unit 217. In particular, the display unit 219 may display the 3D image, using the left image data of the first broadcast and the right image data of the second broadcast data.

For example, the display unit 219 may display a 3D image based on a field sequence scheme forming a 3D frame by alternating between the left image data and the right image data in a field unit, a line-by-line scheme forming a 3D frame by alternating the left image data and the right image data in a line unit, and the like, but is not limited thereto.

In the hierarchical broadcasting system for the 3D broadcast according to example embodiments of the present invention, the first broadcast data may correspond to the left image data, and the second broadcast data may correspond to the right image data, but the first broadcast data and the second broadcast data are not limited thereto, and the first broadcast data may refer to the right image data and the second broadcast data may refer to the left image data.

The hierarchical broadcasting system for the 3D broadcast according to example embodiments of the present invention may provide a 3D image by providing a hierarchical broadcasting through transmitting and receiving a residual signal between left image data and right image data via a second communication network aside from a first communication network transmitting and receiving the left image data, using two heterogeneous networks or an identical communication network. Such a function may be provided selectively through contents protection or a payment system, based on a characteristic of a network transmission.

Also, the hierarchical broadcasting transmission system for the 3D broadcast according to example embodiments of the present invention may support an enhanced 3D image broadcast as well as achieve a compatibility with an existing broadcast reception apparatus as the existing broadcast reception apparatus failing to support a 3D image broadcast is enabled to display, using the existing broadcast data only, by transmitting existing broadcast data via the first communication network. Here, the 3D image broadcast may refer to at least one of a digital television (DTV) broadcast of a 3D image, a mobile television (TV) broadcast of a 3D image, a satellite broadcast of a 3D image, and a cable broadcast of a 3D image.

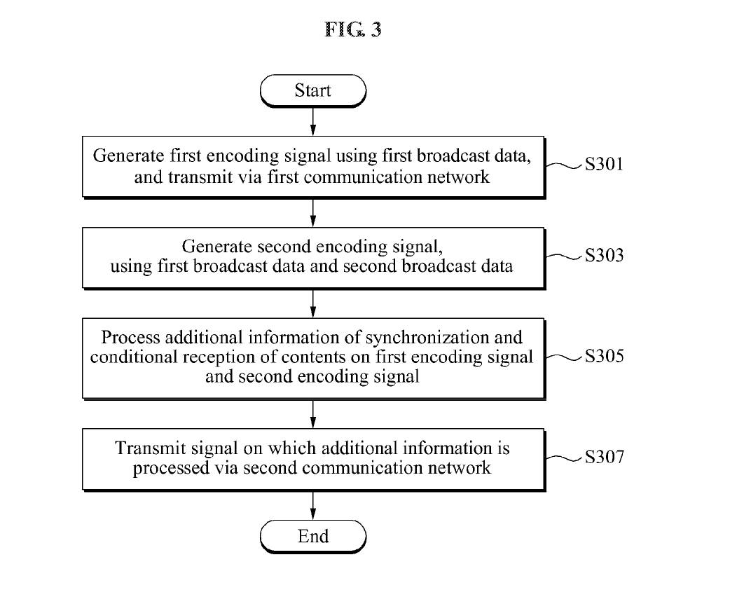

FIG. 3 is a flowchart illustrating a hierarchical broadcasting transmission method for a 3D broadcasting service according to an example embodiment of the present invention.

Referring to FIG. 3, in operation S301, a hierarchical broadcasting transmission system may generate a first encoding signal, using a first broadcast data, and transmit the generated first encoding signal via a first communication network.

In particular, the hierarchical broadcasting transmission system may generate the first encoding signal by encoding left image data of the first broadcast data based on a first encoding scheme, and transmit the generated first encoding signal via the first communication network. Here, the first communication network may refer to a broadcasting network for broadcasting a broadcast signal, and a broadcasting network provided in, for example, the ATSC standard supporting a digital broadcast. Also, the first communication network may refer to, but is not limited to, a communication network supporting a mobile broadcasting service or a satellite broadcasting service.

Further, in operation S303, the hierarchical broadcasting transmission system may generate a second encoding signal using the first broadcast data and a second broadcast data.

In particular, the hierarchical broadcasting transmission system may generate a residual signal, using a difference between left image data of the first broadcast data and right image data of the second broadcast data, and encode the generated residual signal based on a second encoding scheme to generate a second encoding signal. Here, a coding efficiency of the second encoding scheme may be higher than a coding efficiency of the first encoding signal.

In operation S305, the hierarchical broadcasting transmission system may process additional information of synchronization and conditional reception of contents on the first encoding signal and the second encoding signal.

More particularly, the hierarchical broadcasting transmission system may insert synchronization information between the first encoding signal and the second encoding signal to the first encoding signal and the second encoding signal, and encrypt or scramble the first encoding signal and the second encoding signal.

Further, in operation S307, the hierarchical broadcasting transmission system may transmit the signal on which the additional information is processed via the second communication network. Here, the second communication network may refer to a communication network differing from the first communication network, for example, an Internet network based on a network, or a communication network identical to the first communication network.

The hierarchical broadcasting transmission system for the 3D broadcast may transmit the first encoding signal transmitted via the first communication network and the second encoding signal transmitted via the second communication network simultaneously, however, is not limited such a transmission scheme, and transmit the first encoding signal and the second encoding signal sequentially or at predetermined intervals. Also, information of a hierarchical 3D image broadcasting service may be inserted into at least one of the first encoding signal and the second encoding signal to be transmitted.

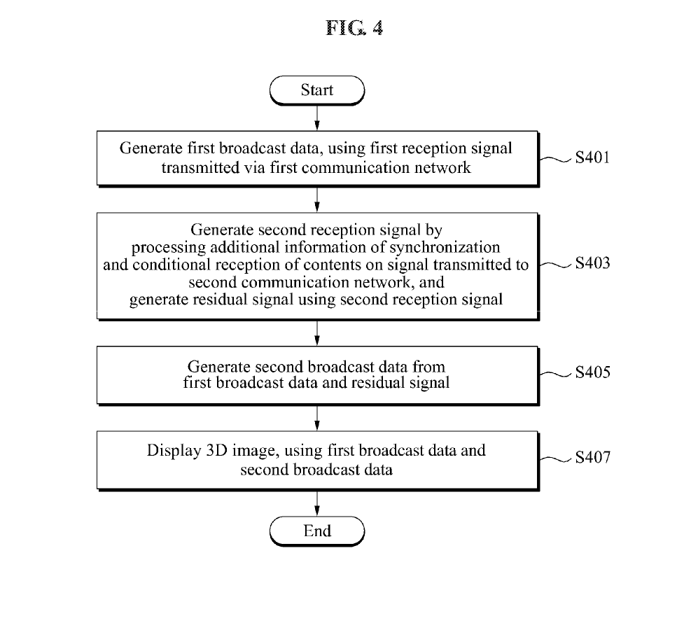

FIG. 4 is a flowchart illustrating a hierarchical broadcast reception method for a 3D broadcast according to an example embodiment of the present invention.

Referring to FIG. 4, in operation S401, a hierarchical broadcasting reception system may generate a first broadcast data, using a first reception signal transmitted via the first communication network.

More particularly, the hierarchical broadcasting reception system may generate left image data, being the first broadcast data, by decoding the first reception signal transmitted via the first communication network, based on a first decoding scheme. The first communication network, as used herein, may refer to a communication network for broadcasting a broadcast signal, and may be, for example, a broadcasting network provided in an ATSC standard supporting a digital broadcast. Also, the first communication network may refer to, but is not limited to, a communication network supporting a mobile broadcasting service or a satellite broadcasting service.

Further, in operation S403, the hierarchical broadcasting reception system may generate a second reception signal by processing additional information of synchronization and conditional reception of contents on the signal transmitted to the second communication network, and generate a residual signal using the second reception signal.

More particularly, the hierarchical broadcasting reception system may extract synchronization information with the first reception signal transmitted via the first communication network from the second reception signal transmitted via the first communication, and decrypt or descramble the extracted synchronization information. Here, the second communication network may refer to a communication network differing from the first communication network, for example, an Internet network based on a network, or a communication network identical to the first communication network.

The hierarchical broadcasting reception system may generate a residual signal between the first broadcast data and the second broadcast data, being a residual signal between the left image data and the right image data by decoding the second reception signal based on a second decoding scheme.

Further, in operation S405, the hierarchical broadcasting reception system may generate the second broadcast data from the first broadcast data and the residual signal.

More particularly, the hierarchical broadcasting reception system may generate the right image data corresponding to the second broadcast data by combining the left image data of the first broadcast data and the residual signal between the first broadcast data and the second broadcast data, being the residual signal between the left image data and the right image data.

Further, in operation S407, the hierarchical broadcasting reception system may display a 3D image using the first broadcast data and the second broadcast data.

In particular, the hierarchical broadcasting reception system may provide a hierarchical 3D image broadcasting service by displaying a 3D image using the left image data of the first broadcast data and the right image data of the second broadcast data. Here, the hierarchical broadcasting reception system may display a 3D image based on a field sequence scheme, a line-by-line scheme, and the like, but is not limited thereto.

The hierarchical broadcasting reception system for the 3D broadcast may receive the first reception signal transmitted via the first communication network and the second reception signal transmitted via the second communication network simultaneously, but is not limited to such a transmission scheme, and may receive the first reception signal and the second reception signal sequentially or at predetermined intervals. Also, information of a hierarchical 3D image broadcasting service may be inserted into at least one of the first reception signal and the second reception signal.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A hierarchical broadcast transmission system, the system comprising:
a first encoder unit to generate a first encoding signal by encoding a first broadcast data based on a first encoding scheme;
a first transmission unit to transmit the first encoding signal via a first communication network;
a residual signal generating unit to generate a residual signal from the first broadcast data and a second broadcast data;
a second encoder unit to generate a second encoding signal by encoding the residual signal based on a second encoding scheme;
a synchronization unit to process synchronization information between the first encoding signal and the second encoding signal on the first encoding signal and the second encoding signal; and
a second transmission unit to transmit the second encoding signal via a second communication network,
wherein the second broadcast data corresponds to right image data when the first broadcast data corresponds to left image data, and
the second broadcast data corresponds to left image data when the first broadcast data corresponds to right image data.

2. The hierarchical broadcast transmission system of claim 1, wherein the first communication network is a broadcast network for broadcasting a broadcast signal.

3. The hierarchical broadcast transmission system of claim 1, wherein the second communication network is a broadcast network differing from the first communication network, or a communication network identical to the first communication network.

4. The hierarchical broadcast transmission system of claim 1, wherein a coding efficiency of the second encoding scheme is higher than a coding efficiency of the first encoding scheme.

5. The hierarchical broadcast transmission system of claim 1, further comprising:
a conditional reception unit for contents to encrypt or scramble the second encoding signal.

6. The hierarchical broadcast transmission system of claim 1, wherein information of a hierarchical three-dimensional (3D) image broadcasting service is inserted into at least one of the first encoding signal or the second encoding signal.

7. A hierarchical broadcast reception system, the system comprising:
a first reception unit to receive a first reception signal via a first communication network;
a first decoder unit to generate a first broadcast data by decoding the first reception signal based on a first decoding scheme;
a second reception unit to receive a second reception signal transmitted via, a second communication network;
a synchronization unit to process synchronization information between the second reception signal and the first reception signal from the second reception signal;
a second decoder unit to generate a residual signal between a first broadcast data and a second broadcast data by decoding the second reception signal based on second decoding scheme; and
a broadcast data generating unit to generate the second broadcast data from the first broadcast data and the residual signal,
wherein the second broadcast data corresponds to right image data when the first broadcast data corresponds to left image data, and
the second broadcast data corresponds to left image data when the first broadcast data corresponds to right image data.

8. The hierarchical broadcast reception system of claim 7, wherein the first communication network is a broadcast network for broadcasting a broadcast signal.

9. The hierarchical broadcast reception system of claim 7, wherein the second communication network is a communication network differing from the first communication network, or a communication network identical to the first communication.

10. The hierarchical broadcast reception system of claim 7, wherein a decoding efficiency of the second decoding scheme is higher than a decoding efficiency of the first decoding scheme.

11. The hierarchical broadcast reception system of claim 7, further comprising:
a conditional reception unit for contents to decrypt or descramble the second reception signal.

12. The hierarchical broadcast reception system of claim 7, wherein information of hierarchical three-dimensional (3D) image broadcasting service is inserted into at least one of the first reception signal or the second reception signal.
